(19) United States
(12) Patent Application Publication
(10) Pub. No.: US 2008/0209039 A1
(43) Pub. Date: Aug. 28, 2008

(54) Service chaining methods and apparatus

(75) Inventors: David Tracey, Drogheda (IE); Helmut Salmen, Los Gatos, CA (US); Brian Gillespie, Dublin (IE)

Correspondence Address: WOLF GREENFIELD & SACKS, P.C., 600 ATLANTIC AVENUE, BOSTON, MA, 02210-2206, US

(73) Assignee: SIMtone Corporation, Durham, NC (US)

(21) Appl. No.: 12/002,389

(22) Filed: Dec. 17, 2007

Related U.S. Application Data
(60) Provisional application No. 60/876,358, filed on Dec. 21, 2006.

(51) Int. Cl. G06F 15/173

(52) U.S. Cl. 709/225

(57) ABSTRACT

According to some aspects, a method of providing services to a first device over a network using a network switching center adapted to locate servers capable of providing the services to the first device is provided. The method comprising acts of identifying a first service to be provided to the first device, providing notification, from the network switching center to a first server, that the remote device has requested the first service, providing, by the first server, the first service to the remote device, and indicating, by the first server to the network switching center, a second service to be provided to the remote device.

### RELATED APPLICATION

This application claims priority under 35 U.S.C. § 119(e) to U.S. Provisional Application Ser. No. 60/876,358, entitled “SERVICE CHAINING METHODS AND APPARATUS,” filed on Dec. 21, 2006, which is herein incorporated by reference in its entirety.

### FIELD OF THE INVENTION

The present invention relates to remote computing, and more particularly, to receiving services from one or more remote servers.

### BACKGROUND OF INVENTION

The flexibility of network computing has changed, in certain respects, the way in which remote access and computing is performed and achieved. In particular, strict notions of location may become increasingly unimportant in a highly networked environment, as information, data, computing power, etc., may be accessible from anywhere via the network. For example, a corporate local area network (LAN) may be available to users who are telecommuting, traveling for business (or pleasure), or otherwise not directly connected to the corporate LAN. The increased proliferation of wireless network technologies, and the ever decreasing cost of hi-speed networks based on these technologies, has accelerated trends towards remote computing solutions.

Users of portable and mobile devices such as laptop personal computers (PC), cellular telephones, personal desktop assistants (PDA), and other portable computing devices may desire access to, and avail themselves of, the vast resources available over a network (e.g., the Internet), including access to the user's corporate LAN and/or one or more other LANs, private networks, etc. A remote user may want to interact with a LAN and enjoy its many services as if the user were locally connected to the LAN. However, such remote computing activities involve substantial security risks to the LAN. For example, access to confidential information of the corporate LAN to which the remote user intends to interact may render the LAN vulnerable to loss or dissemination of the confidential information.

A private LAN may need to protect itself against unauthorized access to data, information and/or services stored on, or provided by, the LAN. Conventional solutions to address security issues inherent in remote access include protecting the LAN behind a firewall. The firewall is configured to provide limited access to the LAN and operates as a gatekeeper to prevent unauthorized users from connecting to, or otherwise accessing the LAN. However, conventional firewall solutions severely restrict the type of access permitted to the LAN, and restrict the type of devices that may access the LAN. In addition, remote access via a firewall is often expensive to implement and complicated to administer and maintain. In addition, conventional firewalls may still leave data and information belonging to the LAN vulnerable to theft, unauthorized and/or accidental modification or deletion, etc.

Individuals who are away from their office often have a continuing need to gain access to their corporate networks. They may need to access files, e-mails, applications and programs that are typically available when the individual is in the office and directly connected to the corporate network. One conventional approach to facilitate remote access is to use laptop personal computers to enable users to access the corporate network to, for example, remotely access their e-mail accounts. To enable this activity, appropriate communications software must be installed on each client laptop PC so that users may remotely access the corporate network to transfer files from/to the network server through a dial-up telephone line (or a broadband connection, such as a digital subscriber line (DSL), T1, cable, etc.). All application programs reside and locally execute on the local client laptop PC. While this approach is relatively simple, it necessitates that each and every such software application be installed, configured and then maintained on each laptop PC. Consequently, over time, this approach can become quite expensive, particularly in view of the on-going support costs of the installed software applications, and the relatively short work life of most laptops before upgrade is required.

Another conventional approach uses a traditional virtual private network (VPN) to provide wide area network (WAN) connectivity from a remote user location to a central corporate LAN. A VPN WAN connection may implement an Open System Interconnection (OSI) layer 2 extension between the LAN and the remote user location. A remote client PC connected through a VPN to a LAN appears as if it is directly connected to the LAN. However, a VPN connection requires expensive VPN termination equipment (or a client-site VPN router) located at each end of the connection, and/or VPN client software installed and configured at the client machine. In either case, the VPN terminator provides layer 2 packet processing as well as appropriate packet encryption/decryption functionality. Although either the PC operating system or client based VPN software can mitigate the cost of the VPN terminator, it both requires considerable packet processing to assemble and disassemble packets, imposing a significant processing burden on the PC. Accordingly, a separate dedicated VPM terminator at the remote user location is often required to support VPN connectivity with required levels of security and reliability without imposing an undue processing load on the client PC itself. Thus, VPN equipment is not only expensive, but tedious to configure and costly to administer and maintain.

In all of the above cases, sensitive corporate data is transferred to the PC/laptop and duplicated between the secure corporate network and the PC/laptop. Once data is downloaded and physically copied, no access or transport security system can prevent unauthorized, uncontrolled distribution and/or misuse of the data. Accordingly, the legitimate data owner is at risk of having confidential information disseminated, or otherwise used without the knowledge and/or permission of the owner.

Still another conventional approach to extending the office environment to remote user locations involves an application service provider (ASP) model requiring the installation of specialized server software on one or more network servers, such as Citrix Corporation's MetaFrame™ software using an independent computing architecture protocol. The network server situated on the LAN functions as an ASP by hosting multiple virtual machines accessible by various different remotely located client PCs. Alternatively, Microsoft Corporation's Windows Terminal Services™ (WTS) using remote desktop protocol (RDP) can be utilized to provide multiple virtual machines. However, both the MetaFrame™ and WTS™ software impose considerable processing loads on the client PC, and are vulnerable to network faults and security breaches, such as “man-in-the-middle” attacks. Additionally, the ASP-based approach may provide limited remote execution functionality.

In general, the systems described above were designed and developed, at least in part, to overcome the bandwidth limitations of prior communications networks. Current technological advances have dramatically increased the bandwidth of the communications network. The network bandwidth is increasing faster than microprocessor speed and doubling approximately every nine months, thereby reducing the value of such systems and technologies, effectively rendering them obsolete in some cases.

### SUMMARY

Some embodiments according to the present invention include a method of providing services to a first device over a network using a network switching center adapted to locate servers capable of providing the services to the first device, the method comprising acts of identifying a first service to be provided to the first device, providing notification, from the network switching center to a first server, that the remote device has requested the first service, providing, by the first server, the first service to the remote device, and indicating, by the first server to the network switching center, a second service to be provided to the remote device.

Some embodiments according to the present invention include a system for providing services over a network, the system comprising at least one network device capable of communicating over the network, a network switching center adapted to locate servers capable of providing services to the at least one network device, and a plurality of servers adapted to provide at least one service to the network device, wherein, upon identification of a first service to be provided to a first network device of the at least one network device, the network switching center is configured to locate a first server from the plurality of servers capable of providing the first service, and to indicate to the first server the first service to be provided, and wherein the first server is configured to provide the first service and indicate to the network switching center a second service to be provided to the first network device.

Some embodiments according to the present invention include a network switching center adapted to communicate over a network with a plurality of network devices and a plurality of network servers, the network switching center comprising at least one network port adapted for communication over the network, and a controller coupled to the at least one network port, the controller adapted to process service requests from the plurality of network devices and service chaining requests by the plurality of network servers, wherein, upon receipt of a first service request from a first network device of the plurality of network devices, the controller is adapted to locate a first server of the plurality of the servers capable of providing the first service, and indicate to the first server the first service to be provided to the first network device, and wherein, upon receipt of a service chaining request from the first server indicating a second service to be provided to the first network device, the controller is adapted to locate a second server of the plurality of servers capable of providing the second service.

### BRIEF DESCRIPTION OF THE DRAWINGS

FIGS. 1A-1F illustrate a system and method for service chaining, in accordance with one embodiment of the present invention;

FIG. 2 illustrates a method of service chaining in accordance with another embodiment of the present invention;

FIG. 3 illustrates a network system incorporating various aspects of service chaining in accordance with a further embodiment of the present invention.

### DETAILED DESCRIPTION

As discussed above, conventional approaches to providing a remote device with access to and services from a local area network and/or one or more remote servers connected to the network have drawbacks associated with costs in hardware and software, complexity and cost in administering and maintaining the system, relatively heavy computing burdens on the remote device, limitations on the type of devices that can be serviced, and/or vulnerability to various security threats. Some of these drawbacks derive from the fact that conventional solutions were designed to address network bandwidth limitations which have been loosened or eliminated by modern high-speed networks. In view of the shortcomings of the prior systems and networks, it is desirable to provide a system and methods for enabling a user to securely access remote services, including desktop services, software applications, email, data files, etc., from anywhere on a network as if the user was located in the office, without compromising security or investing in substantial new hardware/software infrastructure.

Conventional remote access techniques allow a user of a remote device to access a service, typically by authenticating the user in some manner, for example, via a login/password combination. The user may then access the service for which it has been authenticated, provided the user is connected to network via a remote device having the appropriate software installed and is configured to access the associated service. However, in conventional remote access, this process must be repeated for each service for which the user desires access. To complicate matters, services provided by different service providers may require different software, infrastructure, etc. to facilitate remote access. Thus a truly general, flexible and secure remote access is not possible using conventional remote access techniques.

Applicant has appreciated that providing a variety of services from one or more service providers using a single authentication/connection process may facilitate a simple, secure and user intuitive architecture for accessing services remotely. According to some embodiments, a network environment is provided to facilitate access by a remote device to one or more servers connected over the network to obtain one or more services. Each service accessed by the remote device may be chained to a subsequent service to be provided to the remote device. The term “service” refers herein to any use of a server over a network at a remote location. A service may include a desktop service, e-mail, access to one or more applications, data, information or other computing task that may be provided by the server. More specifically, a service may be any program, code or application that executes on a server, wherein the executed code interacts with the remote device.

A connector service is a particular type of service distinguished from the more general service by the manner and/or format in which content is delivered to a remote device using the service. A connector service refers herein to one or more programs that execute on a server to perform one or more functions to facilitate transforming data from its native format to an interactive format. For example, a connector service may translate data resident at the service provider into an interactive format comprised of rendering commands that instruct a remote device how to render the data to an output device (e.g., a display, speaker, etc.) on the remote device. For example, the rendering commands may include a bit stream representing pixels, audio, video, etc., for display on the remote device.

A connector service facilitates remote access of a service without having potentially confidential data transmitted from the service provider and/or stored at the remote device, thus providing secure access to the service. The connector service also permits remote devices to access services without having to have software installed to handle data in its native format, thus enabling stateless devices to access a variety of services. The term “chained” or “chaining” refers herein to circumstances in which one server or service selects, specifies or otherwise references the next service to be performed such that multiple services may be performed without requiring the remote device to re-authenticate and/or re-select a desired service.

Managing information systems efficiently has never been more difficult or more important in modern computing environments. As the cost of ownership for desktop systems escalates, corporations need ways to reduce purchase and upgrade costs, and administration and maintenance expenses. However, these savings should not result in a loss of functionality or performance. Generally unrestricted access to high performance applications remains an important concern in managing information systems efficiently. Thus, it is desirable to have a service provisioning system architecture that can provide an unrestricted, native and secure remote access without modifying, or with minimal changes to, existing hardware and software infrastructure.

Applicant has developed a network architecture that facilitates relatively simple access using secure communications between a remote device and one or more servers connected to the network (e.g., a LAN) using a trusted intermediary to broker an initial connection between the one or more servers connected to the network and the remote device. The architecture facilitates the chaining of services provided to the remote device, as described in further detail below. Several embodiments of a network architecture suitable for use with the various aspects of the invention are described in U.S. patent application Ser. No. 10/328,660, entitled “System and Method for Provisioning Universal Stateless Digital and Computing Services,” filed on Dec. 23, 2002, and U.S. patent application Ser. No. 10/328,660, 11/104,982, entitled “System and Method for Automatically Initiating and Dynamically Establishing Secure Internet Connections Between a Fire-walled Server and a Fire-walled Client,” filed on Apr. 12, 2005, both applications of which are herein incorporated by reference in their entirety.

Following below are more detailed descriptions of various concepts related to, and embodiments of, methods and apparatus according to the present invention. It should be appreciated that various aspects of the invention described herein may be implemented in any of numerous ways. Examples of specific implementations are provided herein for illustrative purposes only. In particular, any of various network implementations and configurations using any of various networks, network protocols, etc., may be used, as the aspects of the invention are not limited to any particular type of network, network configurations, and/or network devices.

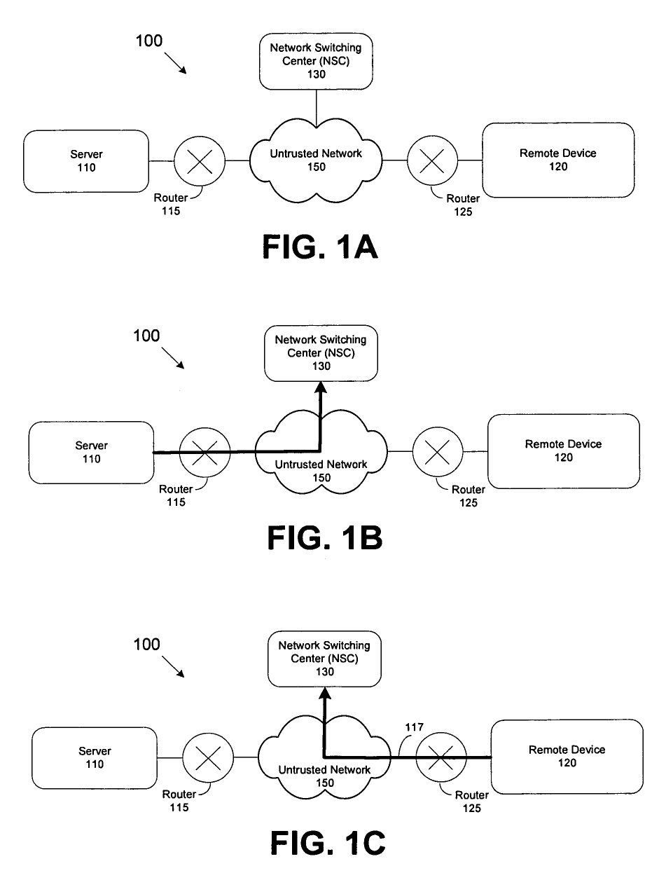

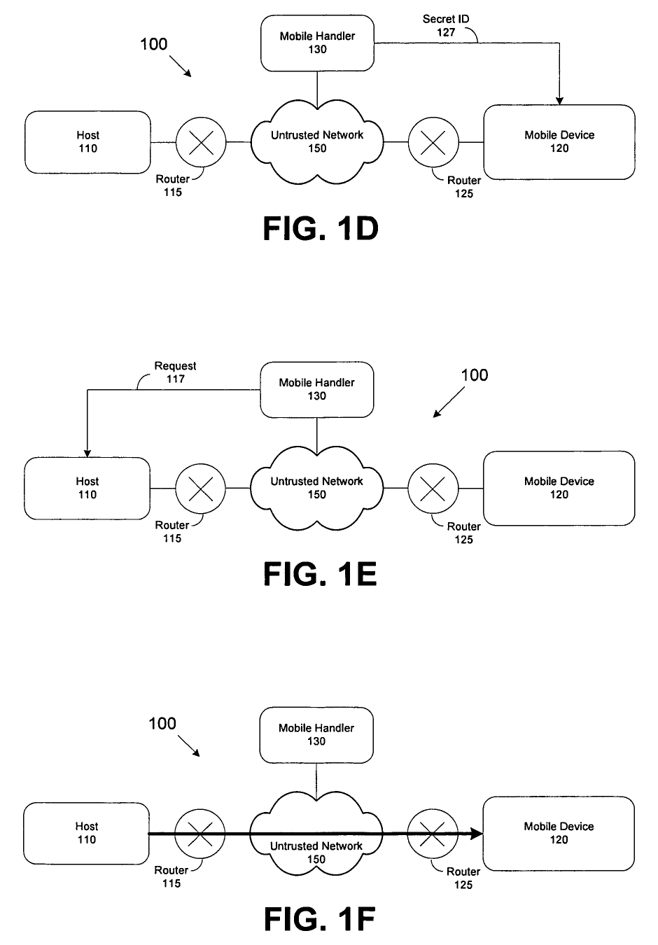

FIGS. 1A-1F illustrate a network architecture for facilitating the provision of one or more services to a remote device, in accordance with some embodiments of the present invention. As shown in FIG. 1A, System 100 includes a server 110 connected to an untrusted network 150 (e.g., the Internet) via router 115. System 100 also includes remote device 120 connected to untrusted network 150 via router 125. Remote device 120 may be connected to the network 150 via a wireless link, or via a hardwired connection. For example, router 125 may include one or more wireless access points that wirelessly connect the remote device to network 150. Alternatively, the remote device 120 may be connected to the network using a wired connection. For example, remote device 120 may be a laptop computer connected to the network via a home office network connection, or some other location offering a wired network port.

The remote device 120 and/or a user of remote device 120 may be unknown to and untrusted by server 110. However, this is not a limitation on the aspects of the invention, as remote device 120 and/or the user of remote device 120 may be either known, trusted or both. For example, server 110 may be located on the corporate LAN of the user attempting to access the corporate LAN from a remote location using remote device 120. In such a scenario, the remote device 120 and the user of remote device 120 may be generally known and trusted by server 110, but server 110 may have limited ability to ascertain the authenticity of either the remote device when it is connected to the network from outside the corporate LAN, or the user of the remote device. System 100 also includes a network switching center (NSC) 130, which is connected to network 150 to facilitate establishing a communication link between remote device 120 and server 110. The server and/or the NSC may also be connected to network 150 via a wireless link, a wired link, or any type of suitable network connection.

It should be appreciated that network 150 may be comprised of a plurality of networks of any type and configuration. For example, network 150 may include numerous networks, with each network being identified by a network identifier portion of the network addresses issued by the various network devices connected to the network. Network 150 may include one or more private networks, local area networks (LAN), wide area networks (WAN), the Internet, etc., as the aspects of the invention are not limited in this respect. Network 150 may include one or more cooperating routers that direct network traffic between different networks, facilitating roaming by remote devices connected to the network. In general, network 150 signifies any collection of one or more networks that are capable to communicating with each other, and is not limited to any type, configuration or number of networks.

NSC 130 is generally known to and trusted by server 110 and may have a trusted link established with the server by which the NSC can communicate information to the server. For example, the server may be connected to the NSC via a Transport Control Protocol (TCP) connection or in the Secure Sockets Layer (SSL). As shown in FIG. 1B, server 110 may initiate and establish a communication link with NSC 130. Alternatively, NSC 130 can initiate the link. However, by having the server initiate the process, server 110 can have greater control over the process to ensure that NSC 130 is trusted. Server 110 may perform any type of security measure or authentication procedure it would like to satisfy itself of the NSC's authenticity and trustworthiness.

Similarly, NSC 130 may be generally known to and trusted by remote device 120. Remote device 120 may be configured to connect to and interact with NSC 130 when it desires communication with server 110, for example, to access one or more services provided by server 110. To facilitate this action, NSC 130 may operate as a trusted intermediary between remote device 120 and server 110. It should be appreciated that NSC 130 may be connected to multiple servers and multiple remote devices to operate as a generally trusted intermediary between any number of trusted and/or untrusted remote device/server pairs, as the aspects of the invention are not limited in this respect. As a general matter, NSC is configured to assist connecting remote device 120 with server 110 such that server 110 can provide one or more services to remote device 120 by a process discussed in further detail below.

As shown in FIG. 1C, the remote device may connect to NSC 130 via a network connection 117 (e.g., an encrypted connection such as SSL, or any other type of connection). When the remote device connects with NSC 130, a temporary identity for the remote device is established for the purposes of authentication. The temporary identity may be comprised of a secret identifier (ID) and a unique network identity (e.g., the remote device's IP address). The temporary identity may be comprised of different or additional identifiers that serve to securely identify the remote device, as the aspects of the invention are not limited in this respect. That is, the NSC may use any of various authentication schemes that can uniquely identify the remote device and that facilitate prevention of malicious devices spoofing the identity of the remote device (e.g., to prevent a bad actor from representing itself to be the authorized remote device to gain access to one or more services and/or to access data and/or other confidential information).

NSC 130 obtains the network address of the remote device used to establish the connection, and generates secret ID 127 to form a unique identifier of the remote device. For example, the NSC may generate a random number as the secret ID. In some embodiments, the secret ID is generated randomly and independent of any known or knowable attributes associated with either the NSC or the remote device to ensure that the secret ID cannot be easily guessed by a malicious attacker attempting to spoof the identity of the remote device. For example, the NSC may generate a random integer value of at least 128 bits, wherein the integer value is unrelated to the IP address, hardware address, geographical location, etc., of the NSC or the remote device. The secret ID and the network ID may together operate as proof, to the NSC, of the remote device's identity and authenticity.

As shown in FIG. 1D, NSC 130 forwards secret ID 127 over the link established between the remote device and the NSC. The NSC and the remote device may be the only entities in possession of the secret ID, which is retained by both for authentication until the remote device restarts, reboots or otherwise undergoes an operation causing the secret ID to expire. While the network address and secret ID operate as the authentication mechanism in system 100, any method of authentication that securely identifies the remote device may be used, as the aspects of the invention are not limited in this respect.

In FIG. 1E, NSC 130 notifies server 110 that remote device 120 would like to connect with the server to access one or more services. The notification from NSC 130 may include the network address of the remote device 120, and may include any additional information needed and/or desired by server 110 (e.g., one or more services that the remote device is requesting). The server 110 then initiates and establishes a communication link with the remote device using the information (e.g., the network address) supplied to it by NSC 130, as shown in FIG. 1F. The server may then provide the requested service to remote device 120.

It should be appreciated that once the connection between server 110 and remote device 120 is established, the NSC may no longer need to be involved in subsequent communication over the establish link between the server and the remote device. That is, the communication path through the untrusted network may not include NSC 130. Thus, the NSC operates as an intermediary to establish the connection, but may not be involved during the resulting communication over the connection, and network packets sent between remote device 120 and server 110 may not be routed through NSC 130. Accordingly, server 110 provides the indicated or selected service to remote device 120. For example, server 110 may provide a desktop service, or access to e-mail or other application local to the server. Server 110 may provide content such as video or audio or other content desired by the user. Any service may be provided, as the aspects of the invention are not limited in this respect.

In a single service architecture, after the server provides the selected service, the server may terminate the connection. Accordingly, remote device 120 may have to initiate another transaction with NSC 130 to obtain an additional service. For example, the remote device 120 may contact the NSC using its secret ID to request another service (i.e., by having the NSC establish a connection with the appropriate server providing the requested subsequent service) and the NSC must perform the necessary functionality to initiate a connection and notify the providing server that remote device 120 intends to access one of its services. This process may need to be repeated each time the remote device requests a subsequent or additional service.

Applicant has appreciated that it may be inconvenient to require the remote device to re-establish contact with the NSC 130 each time it seeks to access another service. In addition, this requirement may make the user experience awkward and unintuitive, such that the user experience does not closely simulate the experience that the user is provided when locally connected, for example, to the user's corporate LAN. The single service structure may limit the server 110 in flexibly providing services to remote device 120. For example, the server 110 may desire to provide another service after one service is complete, or enlist another server to provide an additional service. In a single service architecture, this is not practicable (or even possible) because the expiration of a service generally terminates the session between the server and remote device.

Applicant has appreciated that various shortcomings of the single service architecture may be eliminated by linking services together in a process referred to herein as service chaining. In service chaining, a current service may include, or a server may provide, a reference to another service such that on the completion, termination and/or suspension of the current service, the referenced service may be enacted. Service chaining offers flexibility to servers in providing multiple services and the opportunity to customize the services that the server provides. Service chaining also provides service providers with an easy to manage method to control which services a user may proceed to from a particular given service. Moreover, service chaining may reduce the burden on the NSC as new servers and services are added to the system, as described in further detail below.

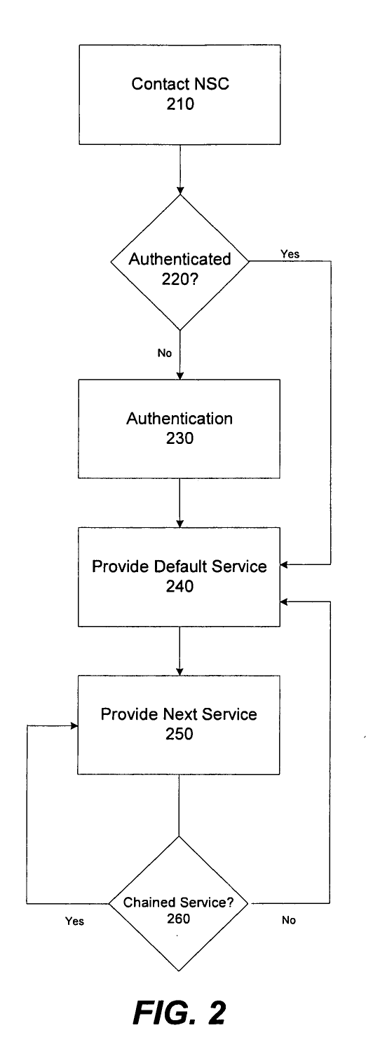

FIG. 2 illustrates a method of service chaining, in accordance with one embodiment of the present invention. Method 200 may be implemented, for example, on the system illustrated in FIG. 1. In act 210, a remote device makes a service request to an NSC to request a service from one or more servers for which the remote device and/or user has subscribed. The service request may merely involve the remote device contacting the NSC. The term “subscriber” refers herein to a network or remote device and/or user that is registered with the NSC and has subscribed to access at least one service over the network. The remote device may be configured to automatically contact the NSC, for example, on start-up, or the contact may be user initiated (e.g., the user may select an option to connect to the NSC, or otherwise indicate that the NSC should be contacted).

In act 220, the NSC receives the service request from the remote device and checks to see if the remote device and/or user has been authenticated. If the remote device and/or user has not been authenticated, the NSC authenticates the remote device and/or user to verify that the remote device/user is registered with the NSC, as shown in act 230. There are a numerous ways in which the remote device/user may be authenticated. In one embodiment, the NSC launches an authentication service that handles the verification process ensuring that the remote device/user is authorized. The authentication service may present a login screen to the remote device so that the user may type in a user name and password. The NSC may then verify that the username/password combination provided by the user is correct, and use the information to identify the subscriber.

In another embodiment, the authentication service operates transparent to the user. For example, authentication information about the remote device may be provided by a subscriber identity module (SIM) card, which stores identity information about the end-user that can be issued programmatically from the remote device. In addition, authentication information may be provided by a smart card embedded or otherwise coupled to the remote device. For example, the remote device may include or be coupled to a smart card reader. The user may provide his/her smart card to the reader to be authenticated in this manner. Alternatively, the authentication information may result from the hardware identification of the remote device such as the network interface card (NIC) identifier. Other authentication information that can be programmatically issued by the remote device and/or obtained by the NSC may be used for authentication, as the aspects of the invention are not limited in this respect. It should be appreciated from the foregoing that authentication may be performed either on the user (e.g., login password, personal smart card, etc.) or the remote device (e.g., SIM number, NIC ID, hardware ID, etc.). Accordingly, the term “remote device/user” is used herein to refer to the remote device and/or the user and does not require both.

In any event, the NSC may then use the provided authentication information to verify the identity of the remote device/user. For example, the NSC may use the authentication information to index and locate a corresponding local identifier of the remote device/user employed internally by the NSC, which is referred to herein as the network subscriber identification (NSI). For example, the NSC may store a globally unique NSI corresponding to each valid subscriber and associate the NSI with the valid and correct authentication information. When the NSC receives the authentication information, it may use the authentication information to index and obtain the NSI corresponding to the remote device that provided the service request.

If there is not an NSI associated with the obtained authentication information, the authentication service may indicate to the remote device that the NSC does not recognize the remote device/user as a valid and authorized subscriber. If there is an NSI associated with the authentication information, a session is initiated and the NSC generates a secret identification for the remote device to use for the duration of the session as discussed above.

As part of connecting with the NSC, the remote device may deliver information related to device parameters and capabilities. For example, the remote device may deliver such operating parameters as screen size, video encoding capabilities, audio capabilities, codex, or any other parameter(s) that may be useful or needed to provide services to the remote device. The device parameters may then be stored in association with the NSI for the remote device. Device parameters may be transmitted before, after, or as part of authentication, as the aspects of the invention are not limited in this respect.

After the session with the remote device is initiated, the authentication service may terminate. A session refers generally to the duration in which a device has been authenticated and does not require further authentication by the NSC (e.g., the remote device is in possession of the secret ID generated and provided by the NSC). A session may terminate for any number of reasons. For example, the session may terminate when the remote device reboots or restarts. The session may also be terminated by express termination from either the remote device or the NSC. It should be appreciated that, other initialization procedures and/or session set-up operations may be performed by the authentication service, as the aspects of the invention are not limited in this respect.

As discussed above, the general architecture for service chaining provides that each service or server, or the NSC may indicate the next service to be provided to a remote device. If no service is chained, then a default service for the subscriber may be provided. For example, the NSC may store a default service to be provided to each respective subscriber. The default service may be a service provided by the NSC (e.g., a selection service) or a reference to a service provided by a server, as discussed in further detail below. Accordingly, the authentication service may either explicitly chain to the default service for the remote device, or the authentication service may simply terminate and, in the absence of a chained service, the NSC will look up the default service associated with the NSI for the remote device. In either event, the default service is provided to the remote device (act 240).

The default service may be any service available to the remote device. The default service may be a selection service that presents the various services available for which the remote device/user has subscribed. For example, the selection service may operate by providing a menu of available services from which the remote device may choose, such as a Windows™ service that emulates the Windows™ environment to allow the remote device to operate as if it were locally connected on the same LAN as the server providing the service, as discussed above. The service may be a display that allows the remote device to conduct a commercial transaction. For example, the remote device may be a television set, and the default service may be a service that allows the user to select a movie to watch (or provide other menu options), which may then be streamed to the television set as part of the selected service. Accordingly, the default service for a device may depend on the type and capabilities of the remote device, preferences set up by a user of the remote device, or aspects of the user's subscription/session.

The default service may be a service provided by the NSC, or may be a service provided by another server connected to the network. If the default service is a service provided by another server, then the NSC initiates the process of connecting the remote device to the appropriate server as described above in connection with FIG. 1. In particular, the NSC may look up the default service in a database to determine the location (e.g., the network address) of the server providing the default service. If the NSC provides the default service (e.g., a selection service), the NSC may wait until a service provided by another server is selected before initiating the connection procedure between a server and the subscriber. It should be appreciated that the default service may be any service of any type provided by any network device, as the aspects of the invention are not limited in this respect.

Once the default service completes, the next service is provided to the remote device (act 250). The next service may be a service chained to from the default or current service. For example, if the default service is a selection service, the next service may be the service selected from the menu of available services. If the next service is provided by a server other than the NSC, the NSC may initiate the connection process and notify the server that the remote device is requesting the selected service. The server may then connect to the remote device as discussed above and provide the selected service. At some point, the next service (which is now the current service being provided) may complete, be suspended and/or may terminate.

Each time a service completes, terminates or is suspended, the NSC checks to see if the current service has provided a next service to be performed, that is, whether the current service and/or current server has chained to another service to be performed (act 260). If a next service has been chained to (e.g., referenced as the next service to be provided), the next service is provided to the remote device. If another service is not chained, the NSC may provide to the remote device the default service that is associated with the NSI of the remote device (i.e., act 240 may be repeated). The next service may be another service provided by the current server to which the remote device is connected, or may be another server entirely. If the service chained to is provided by another server, the NSC may initiate a connection between the new server and the remote device in the manner described in connection with FIG. 1. Act 260 may be repeated until no next service is chained, in which case the NSC may provide the default service to the remote device. In this manner, a service chaining method may be implemented on the network system illustrated in FIG. 1.

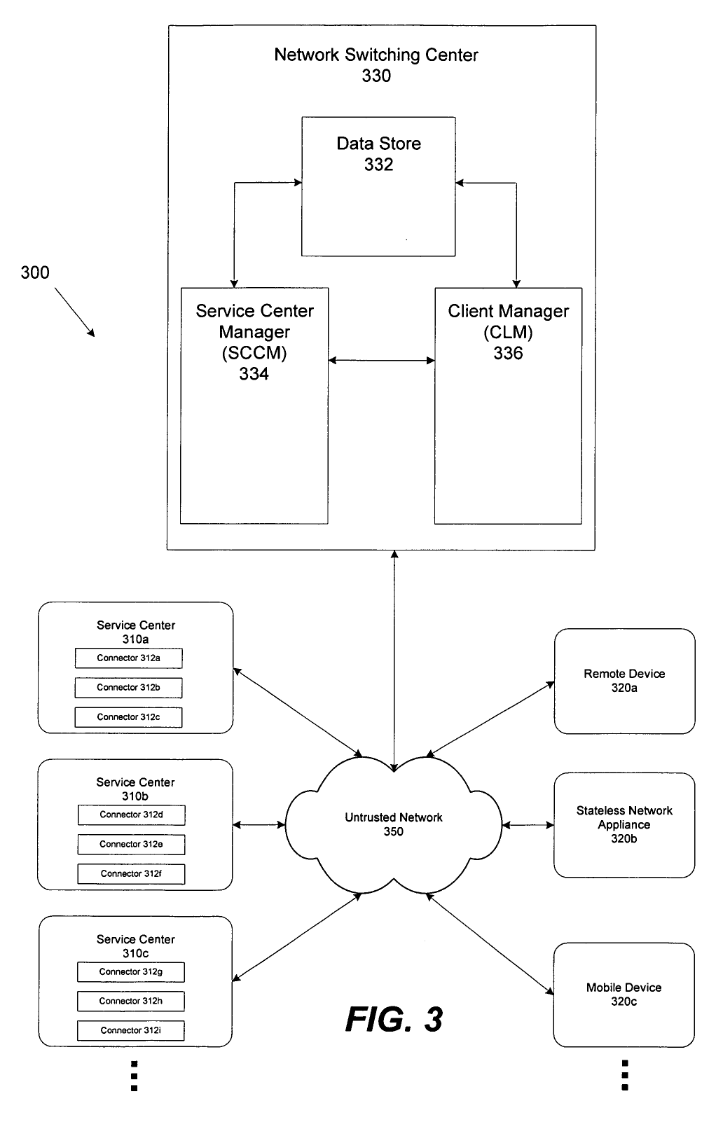

FIG. 3 illustrates a system implementing service chaining, in accordance with some embodiments of the present invention. In system 300, a variety of remote devices 320 are connected to the network and utilize NSC 330 to access services provided over the network. In addition, a plurality of service centers 310 are connected to the network and NSC 330. A service center refers to any collection of one or more servers configured to operate in connection with an NSC to provide one or more services to requesting remote devices. The service centers may include one or more servers providing services to authorized subscribers. For example, service center 310a may be a corporate LAN of one or more users that provides remote access via various remote devices 320. Services center 310b may be a commercial provider of electronic media. For example, service center 310b may be a vendor of video and/or audio to be provided to a remote device for viewing and/or listening. Service centers 310 may be any collection of one or more servers providing any type and/or variety of services, as the aspects of the invention are not limited in this respect.

Remote device 320a may be any network device capable of connecting to the network 350. For example, remote device 320a may be a laptop or home PC that a user employs to gain access to one or more remote services such as work e-mail or other applications accessible by the remote device. Stateless network appliance (SNAP) 320b is also connected to the network to access one or more services available to the SNAP over network 350. A stateless device refers herein to a device that can operate substantially as a network and display management device. In particular, the stateless device may operate chiefly as a human interface device to a network when operating in its stateless capacity. A stateless device typically does not run any applications or download any software other than software that performs network functionality and displays information received over the network. As a result, a stateless device (when operating in its stateless capacity) need not perform substantial user functionality and/or contain any significant and/or permanent user data.

Enabling a stateless device to access, interact with and/or receive services from other network devices mitigates and/or eliminates one or more problems associated with conventional network computing. For example, stateful computing devices are largely responsible for a number of security issues such as providing user functionality that facilitates hacking, establishing a computational environment to both host and spread viruses, and/or otherwise enabling a user to breach security, attack vulnerabilities in a network environment, and/or otherwise exploit the functionality of stateful devices.

A stateless device, by contrast, is largely stripped of the functionality that facilitates the various capabilities described above. However, a stateless device in conjunction with the above described architecture, permit the stateless device to operate as a so-called “dumb terminal,” yet still benefit from resources available over the network. In particular, a stateless device may simulate any computing environment without requiring the device itself to be enabled with the associated functionality. For example, a stateless device, interacting with a network service, may access a user's Windows™ environment without requiring the Windows™ operating system to be installed on the stateless device. Since the stateless device is operating as an interface to the network, it may be presented information over the network that allows it to simulate any device or functionality, without requiring the attendant drawbacks associated with the requirement that the functionality be resident on the stateless device.

Stateless devices facilitate a shift in network computing from a paradigm in which the computational and functional burden is on the device connecting to the network (e.g., a laptop or PC) to a paradigm in which functionality and computation may be chiefly performed by servers connected to the network. Amongst some of the advantages described above, this new paradigm allows devices that traditionally do not enjoy, or enjoy limited network capabilities (e.g., televisions, or any other device having a display) to become fully network capable devices. Stateless devices present a relatively inexpensive means to fully interact with and access services over one or more networks, while preserving the integrity of data maintained by hosts/servers to which the stateless device is interacting/interfacing.

It should be appreciated that a stateful device (such as a personal computer, personal digital assistant, etc.) may operate in a stateless capacity. That is, a stateful device may operate as a stateless device by suppressing, to some extent, its full capability as a stateful device such as executing applications, storing user data and information, etc. Purely stateless devices, though, operate substantially as a network appliance that allow a user to interface with information on a network that is stored elsewhere, and/or to receive services and functionality that is computed, performed and provided from some other location on the network (e.g., by one or more hosts or servers to which the network appliance is connected). Further benefits associated with stateless devices in the context of system 300 are described in further detail below.

In FIG. 3, system 300 also includes mobile device 320c connected to the network 350 and capable of communicating with NSC 330. Mobile device 320c may be any number of generally mobile devices such as a laptop, a cellular phone, a personal desktop assistant (PDA), or any other device capable of communicating with the network. Mobile device 320c may be a stateless or a stateful device. It should be appreciated that there are no limitations placed on the number and type of remote devices 320 connected to the network, and the configuration illustrated in FIG. 3 is merely exemplary to illustrate a few possible incarnations of remote devices and service centers that may be connected to form a system on which various aspects of the present invention may be implemented.

NSC 330 may operate in a similar manner to NSC 130 described in connection with FIG. 1, and the NSC described in connection with the service chaining method described in connection with FIG. 2. To implement these capabilities, NSC 330 may include database 332 to store information about remote devices/users and service centers. Database 332 may include multiple databases of any type. For example, database 332 may include one or more relational or object oriented databases. Database 332 may store information about the one or more remote devices for which the NSC may act as an intermediary to establish connections with a service center, and to generally facilitate the process of providing one or more services to the remote device/user. Database 332 may include a subscriber table 332a to store, in association, NSI's and information relevant to a session such as available services, service specific identification numbers, device parameters, etc., as described in further detail below.

NSC 330 may also include a client manager (CLM) 336 adapted to communicate with registered devices/users and to administer and maintain current sessions. CLM 336 is coupled to database 332 to obtain information and update the database with respect to current sessions with devices/users. CLM 336 may be one or more software components or modules programmed to perform various operations to facilitate providing access to one or more services provide by the service centers, as discussed in further detail below.

NSC 330 may also include service center manager (SCCM) 334 adapted to communicate with service centers 310 and to administer and maintain sessions with the service centers. SCCM 334 is coupled to database 332 to obtain information about available services/service centers and update the database with respect to current services being provided. SCCM 334 may be one or more software components or modules programmed to perform various operations to facilitate providing access to one or more services provided by the service centers. Together, the CLM 336, operating on the subscriber side, and the SCCM 334 operating on the service center side, operate to establish an initial connection between a subscriber and a service center and perform various other operations to facilitate the provision of services to the subscriber in a service chaining environment, as discussed in further detail below.

The NSC stores a unique identifier (i.e., an NSI) for each remote device/user that is registered with the NSC. The NSC uses the NSI to uniquely identify each remote device on the network and to associate the device with information about the device and available services. The NSI for each subscriber may be maintained at the NSC and not shared with either the remote device or the service centers. The NSI may be stored in subscriber table 332a and associated with authentication information used to authorize and authenticate a remote device/user. For example, the NSI may be stored in association with login information such as a username/password pair that a user of a remote device provides, or by which the remote device automatically issues when it intends to access one or more services. Alternatively, the NSI may be stored in association with a SIM number, smart card ID, or other hardware address identifier (such as a NIC identifier) that identifies the remote device and/or user in a secure manner.

A service request issued from a remote device requesting access to a service is processed by CLM 336 which, in response, may initiate the NSC's authentication service. The authentication service may be configured to present the remote device with an authentication process that depends on the type of authentication or login information the CLM is expecting. For example, if the CLM is expecting a username/password pair, the authentication service may provide the remote device with a login display requesting the user to input the appropriate username/password pair. If the remote device programmatically issues a SIM number or NIC ID upon making the service request, the authentication service may need not present anything to the user, but may proceed to process the provided authentication information.

In any event, the provided login information received by the CLM by whatever means is used by the authentication service to index the subscriber table to obtain the NSI for the remote device. If no NSI is found in association with the provided login information, the authentication service may notify the user that the login information is invalid. If an associated NSI is found, the CLM can identify the subscriber and initiate service access according to the information stored in association with the NSI for the identified and authenticated subscriber. The authentication service may also perform various query operations to obtain capability parameters from the remote device. The authentication service may also initiate a session and generate a secret ID for the remote device to use throughout the session. The authentication service may encrypt the secret ID and transmit it to the remote device 320. The secret ID may then be used between the NSC and remote device for the session to avoid requiring the remote device to repeatedly login and re-authenticate itself. That is, the NSC may associate the secret ID with the corresponding NSI and the remote device may transmit the secret ID in future communications with the NSC. After the remote device has been authenticated as an authorized subscriber, the authentication service may terminate.

CLM 336, equipped with the remote device's NSI, may look-up the default service for the subscriber in the subscriber table. In particular, each NSI may have associated with it the default service for the subscriber including a service name that references or otherwise identifies the first or default service to be provided to the subscriber pending successful authentication. For example, the default service may be an end-user service such as a Windows™ service that emulates a Windows™ desktop so that the remote device may operate as if connected to its corporate LAN. Alternatively, the default service may be a selection service that displays to the remote device the available services from which the subscriber may select a desired service. The default service may be a service provided by the NSC or any service center connected to the network. For example, the default service for a simple stateless display device or simple audio player may be a service provided by a corresponding service center that displays available video (e.g., movies) or audio for download or streaming to the device.

When the default service is a service provided by one of the service centers, or the user selects a service provided by one of the service centers, SCCM 334 contacts the appropriate service center to facilitate establishing a connection between the service center and the subscriber. For example, database 332 may include a subscriber services table 332b that associates service names with information necessary to contact the appropriate service center. This information may include the network address and/or any other identifying information of the appropriate service center that the SCCM needs to locate and contact the service center. The SCCM may then contact the service center using this information obtained using the service name as an index.

As discussed above, the NSI may be known only by the NSC and, for security purposes, used solely for internal purposes. Accordingly, the NSC may want to keep the NSI of each subscriber secret and hidden from both the service centers and the remote device/user that it identifies. Rather than provide the NSI to the service center, the NSC may generate a service subscriber identifier (SSI) that associates the subscriber with a service being selected. The NSC may then send the SSI of the subscriber for this particular service and the network address of the subscriber to the service center so that the service center may establish a connection with the remote device.

Internally, the NSC may associate the SSI for each service with the NSI of the subscriber accessing the service. In particular, SCCM 334 may store in a tuple the NSI, SSI and the service name for the subscriber. Since the remote device may request multiple services, each NSI may have multiple SSI's and service names associated with it. As discussed above, the service center establishes a connection with the remote device using the network address provide by the NSC. After the connection has been established, the service center may perform the service requested by the remote device over the established connection. However, when the service terminates, for example, because the service has been completed, the user indicates that he no longer needs the service, or the user indicates that another different service is desired, it is inconvenient to require the remote device to have to repeat the service selection steps with the NSC in order to access another service.

Applicant has appreciated that having the current service or service center indicate the next service to be provided, allows increased flexibility and provides a user experience that more closely simulates being directly connected to the service center, for example, directly connected to the corporate LAN. Accordingly, when a current service is going to terminate, or the service is to be temporarily suspended, the service center has the opportunity to link to another service. In FIG. 3, the service center notifies the NSC that either the current service is going to temporarily be suspended, or the service has been completed. With this notification, the service center may indicate the next service to be provided, or the service center may complete the service and terminate without service chaining.

Alternatively, the service center may indicate to the NSC the next service to be provided without terminating the current service. The latter allows the current service to resume when the indicated next service has been completed. Thus, a service center can indicate another service to be provided as a result of an action by the remote service without terminating the current service. This allows the service center additional controls and permits a service center to make use of services provided by other service centers, greatly improving the flexibility and usability of the architecture.

When a service has been chained, CLM 336 obtains the indicated service name (or other reference to a service) and determines whether the remote device/user is authorized to access the service (i.e., whether the remote device/user is a subscriber to that service). That is, CLM 336 obtains the NSI of the remote device and checks to see whether the service name is associated with the indicated service. If the remote device/user is authorized for this service, the SCCM obtains the information needed to contact the service center for this service along with the associated SSI and notifies the service center associated with this service so that the service center may establish a connection with the remote device to begin providing the next service. This process of service chaining can be repeated to provide any number of linked services to the remote device. In addition, this type of service chaining may be transparent to the user to provide an intuitive transition between services.

Service chaining allows service centers the flexibility of structuring the services provided to a remote device without burdening the NSC with having to understand this structure. For example, service chaining permits a service center to run its own authentication service prior to providing a service selected by the remote device. A service center may elect to have its own special authentication procedure to ensure that the remote device is authorized to access the services provided by the service center. For example, a corporate LAN may want to verify that a remote user is authorized to access information and services available at the LAN and may issue login/password combinations only to its employees. Accordingly, a service center may perform any desired authentication procedure and then chain to the service selected by the remote device.

In addition, service chaining allows one service center to take advantage of services provided by other service centers by being able to chain to those services. For example, service chaining allows different service centers to form agreements between themselves to allow their services to be chained to each other's services, without requiring the active involvement of the NSC other than, for example, a database check of the relevant data. In one embodiment, a service center that chains to a service provided by another service center may include in the service chaining message or change of service request an identifier or secret known between the two service centers. The NSC may then forward this secret on to the service center being chained to.

The chained service center may then check the forwarded secret against an expected secret from the service center from which it was chained to ensure that the service center is authorized to chain to services provided by the chained service center. The chaining secret may be used to give service centers a greater level of control and security over its services by ensuring that services centers that chain to it are authorized. However, identifiers or secrets from one service center to a chained service center are not required, as the aspects of the invention are not limited in this respect.

In FIG. 3, each of the service centers 310 include a plurality of connectors 312. Each of the connectors may be associated with a particular service provided by the corresponding service center. The connectors may be configured to transform information generated by respective services operating at the service centers (i.e., data in the native format of the software operating on the service center) to an interactive format (i.e., the service operates as a connector service). The interactive format may include rendering commands that describe how and what to display on the remote device so that the remote device can interact with the data at the service center without the service center having to transmit the data and/or the remote device having to store the data or have the associated software installed to itself manipulate the data in its native format.

In some embodiments, the rendering commands include a bitstream to be displayed on the remote device. The term “display bitstream” refers herein to information representing pixels to be displayed on a display device, audio, video or other media that can be output to the user. By converting results and/or content generated by the service to a display bitstream, the remote device need not ever store a local copy of files, documents or other information related to the service being provided to the remote device. Rather, the remote device displays results for the user to view and/or hear, but does not transfer the actual data to the remote device. Thus, the manipulation of information and the actual content remains at the service centers.

Applicant has identified and appreciated many benefits to providing connector services. First, security is improved because the remote device cannot directly modify, delete or distribute information controlled by the service center. Second, the remote device may not need to have specialized software to interact with the service centers and to avail itself of connector services available over the network. The remote device may be a SNAP having the limited hardware and software needed to provide the display bitstream to the user. Accordingly, connector services facilitate a network environment where the remote device operates as a generic network interface to allow users to access any type of connector service available.

The remote devices may also include connectors that translate user inputs (e.g., mouse clicks, keyboard entries, voice commands, or other input provided by the user via the remote device) into the interactive format. The connectors at the servers may then translate the interactive format into commands that instruct the service how to manipulate the data in its native format. In this manner, the bi-directional translation of data facilitates provision of services over the connection without native data being transferred over the connection and/or stored by the remote device while still appearing to the user that the he/she is directly manipulating the data and/or accessing the service locally.

The network architecture described in FIGS. 1 and 3 facilitate secure remote access from a remote device. As discussed above, the network architecture facilitates a shift of the computing burden from the remote device to the service center. In some embodiments, computations involved in providing services to a remote device are substantially performed at the service center and communications sent to the remote device are largely or entirely in the form of rendering commands that include display data. In this manner, remote devices need not have specific software installed locally to provide the wide variety of services that the remote device may want to access. That is, the remote device need not have any knowledge of the types of applications and details of the services being provided in order to interface with the network to access the services and take advantage of its benefits.

In particular, the remote device need not locally execute software involved in the services being provided since the remote device may operate substantially as a display of results, actions, and tasks performed at the service center. That is, data from the service center may be presented to the user as display information, such as a bitmap, to be blit to the display of the remote device. The user's interaction with the display may then be transmitted to the service center where the necessary response to the interaction is performed. In this manner, no data is downloaded to and no specific software application is executed on the remote device (i.e., the remote device is stateless). This prevents confidential information from being stored locally on the remote device. In addition, by removing the requirement that a remote device operate service specific software reduces upgrade and maintenance costs since they are only incurred at the service center.

In FIG. 3, the service centers include connectors 312 to facilitate implementing the paradigm in which display information is provided to the remote device. The service center may, for example, include a connector for each service that it provides. However, a single connector may handle multiple services, as the aspects of the invention are not limited in this respect. The connector is configure to translate data resulting from computations performed by a service center into rendering commands to be sent to the remote device accessing a service. The connector may be one or more software programs or modules that transform the display results of actions performed by the service center into display data capable of being viewed by a user of the remote device. As discussed above, this allows the services to be substantially or entirely performed at the service center, relieving the remote device from needing the know-how, hardware and software, memory requirements, etc., typically required in conventional service access architectures that rely on the stateful capabilities of the remote devices.

As discussed above, one benefit of this architecture is that a relatively simple device (e.g., a dumb terminal) may be capable of providing an interface to any number and variety of different services. This provides flexibility as to the type of devices that may access and utilize the benefits of the wealth of services available over a network (e.g., the Internet). For example, services over a network may now be available to not only general purpose computers such as laptops, PCs, PDAs, etc., but to televisions, cellular phones, and any other network appliance that includes a display and an interface to allow a user to interact with the display. This, in combination with service chaining, allows a shift in paradigm in network computing and facilitates relatively simple, secure and inexpensive access to network services and remote computing.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed function. The one or more controller can be implemented in numerous ways, such as with dedicated hardware, or with general purpose hardware (e.g., one or more processor) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, it should be appreciated that one embodiment of the invention is directed to a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. The invention is capable of other embodiments and of being practiced or of being carried out in various ways. In particular, various aspects of the present invention may be implemented in connection with any type, collection or configuration networks. No limitations are placed on the network implementation. Accordingly, the foregoing description and drawings are by way of example only.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A method of providing services to a first device over a network using a network switching center adapted to locate servers capable of providing the services to the first device, the method comprising acts of:
identifying a first service to be provided to the first device;
providing notification, from the network switching center to a first server, that the remote device has requested the first service;
providing, by the first server, the first service to the remote device; and
indicating, by the first server to the network switching center, a second service to be provided to the remote device.

2. The method of claim 1, further comprising an act of locating, by the network switching center, the first server capable of providing the first service.

3. The method of claim 2, further comprising an act of locating, by the network switching center, a second server capable of providing the second service.

4. The method of claim 3, wherein the first server and the second server are different servers.

5. The method of claim 4, wherein the first server and the second server have a service chaining agreement and a secret identifier that identifies the first server and the second server with each other, and wherein indicating the second service includes providing the secret identifier to the network switching center.

6. The method of claim 5, further comprising providing, by the network switching center, the secret identifier to the second server.

7. The method of claim 3, wherein the first server and the second server are a same server.

8. The method of claim 1, further comprising an act of authenticating the first device, the authentication being performed by the network switching center to verify that the first device and/or user of the first device is registered with the network switching center.

9. The method of claim 1, wherein the act of identifying the first service includes an act of identifying, by the network switching center, a default service to provide to the first device.

10. The method of claim 1, wherein the act of identifying the first service includes an act of selecting, via the first device, the first service from a list of available services.

11. The method of claim 1, further comprising acts of:
providing notification, from the network switching center to the second server, that the second service has been requested; and
providing, by the second server, the second service to the remote device.

12. The method of claim 11, wherein the second service is provided without the user of the first device having to re-authenticate with the network switching center.

13. The method of claim 11, wherein the second service is provided without the user of the first device having to select the second service.

14. A system for providing services over a network, the system comprising:
at least one network device capable of communicating over the network;
a network switching center adapted to locate servers capable of providing services to the at least one network device; and
a plurality of servers adapted to provide at least one service to the network device,
wherein, upon identification of a first service to be provided to a first network device of the at least one network device, the network switching center is configured to locate a first server from the plurality of servers capable of providing the first service, and to indicate to the first server the first service to be provided, and wherein the first server is configured to provide the first service and indicate to the network switching center a second service to be provided to the first network device.

15. The system of claim 14, wherein the first network device is configured to contact the network switching center to access the first service provided by the first server.

16. The system of claim 15, wherein the network switching center is adapted to authenticate the first network device and/or a user of the first network device to verify that the first network device and/or the user is registered with the network switching center.

17. The system of claim 15, wherein the network switching center is configured to identify a default service to be provided to the first network device subsequent to authentication.

18. The system of claim 14, wherein, in response to the indication of the second service, the network switching center is configured to locate a second server from the plurality of servers and indicate to the second server the second service to be provided to the first network device.

19. The system of claim 18, wherein the second server and the first server are different servers.

20. The system of claim 19, wherein the first server and the second server have a service chaining agreement and a secret identifier that identifies the first server and the second server to each other, and wherein the first server is adapted to provide the secret identifier to the network switching center when the first server indicates the second service.

21. The system of claim 20, wherein the network switching center is configured to provide the secret identifier to the second server.

22. The system of claim 18, wherein the second server and the first server are a same server.

23. The system of claim 14, wherein the network switching center, upon receipt of a service change request without reference to a next service to be provided, is configured to provide a default service to the first network device.

24. A network switching center adapted to communicate over a network with a plurality of network devices and a plurality of network servers, the network switching center comprising:
at least one network port adapted for communication over the network; and
a controller coupled to the at least one network port, the controller adapted to process service requests from the plurality of network devices and service chaining requests by the plurality of network servers,
wherein, upon receipt of a first service request from a first network device of the plurality of network devices, the controller is adapted to locate a first server of the plurality of the servers capable of providing the first service, and indicate to the first server the first service to be provided to the first network device, and wherein, upon receipt of a service chaining request from the first server indicating a second service to be provided to the first network device, the controller is adapted to locate a second server of the plurality of servers capable of providing the second service.

25. The network switching center of claim 24, further comprising a database coupled to the controller, the database storing information about a plurality of subscribers and services available to the respective subscribers.

26. The network switching center of claim 25, wherein the controller is adapted to, upon receipt of the first service request from the first network device, authenticate the first network device by verifying that the first network device is registered with the network switching center based on the information stored in the database.

27. The network switching center of claim 26, wherein, subsequent to authenticating the first network device, the controller is adapted to reference the database to identify a default service associated with the first network device.

28. The network switching center of claim 27, wherein the default service is a selection service listing services available to the first network devices based on information stored in the database, and wherein the controller is adapted to provide the selection service to the first network device.

29. The network switching center of claim 28, wherein, upon receipt of an indication from the first network device of the first service, the controller locates the first server from information stored in the database.

30. The network switching center of claim 27, wherein the default service is the first service, and wherein the controller is adapted to locate the first server subsequent to obtaining the default service.
